(19) United States
(12) Patent Application Publication
(10) Pub. No.: US 2012/0119972 A1
(43) Pub. Date: May 17, 2012

(54) GSM ANTENNA, IN PARTICULAR FOR A DEVICE USING THE PUBLIC NETWORK

(75) Inventor: Jean Paul Borlee, Bures sur Yvette (FR)

(73) Assignee: SUEZ ENVIRONNEMENT, PARIS LA DEFENSE (FR)

(21) Appl. No.: 13/379,082

(22) PCT Filed: Jun. 15, 2010
(86) PCT No.: PCT/IB10/52669

§ 371 Date: Jan. 26, 2012

(30) Foreign Application Priority Data
Jun. 19, 2009 (FR) 0902989

(51) Int. Cl. H01Q 1/40

(52) U.S. Cl. 343/873

(57) ABSTRACT

The invention relates to a GSM antenna for transmitting or receiving information between a machine or a network of machines and a server, said antenna including a metal strand (9) embedded in a mechanically resistant flat shield (8) made of an insulating material, suitable for providing mechanical protection to and a seal around the metal strand.

The invention relates to a GSM antenna for transmitting or receiving information between a machine, or a network of machines, and a server, the antenna comprising a metal strand embedded in an insulating material.

Communication between machines (often abbreviated to “M2M”—Machine-To-Machine) generally designates a communication from a machine or a network of machines to a server centralizing the data uploaded by these machines and also remotely controlling these machines.

The invention relates in particular to “M2M” gateways and devices that use the GSM/GPRS/3G/3G+ public network, designated for simplicity as “GSM”, to communicate, transmit or receive the information managed.

The GSM antennas that are currently available on the market are, mostly, suited to mobile uses, that is to say that they are generally designed to be connected to handheld appliances, or else to transmitters mounted in vehicles (cars/trucks/trains).

U.S. Pat. No. 5,701,129 discloses an antenna of this kind for cell phones with a helical strand embedded in a protective frame made of plastic material.

The characteristics of these “mobile” models do not allow them to be used in good conditions when stationary for communication (permanently installed or for measurement campaigns over limited periods) for example on water or gas networks, or on fixtures and fittings or urban infrastructure equipment. Mobile antennas are generally very fragile and require a very particular support, of the car bodywork or windshield type, to be fastened and/or operate satisfactorily; they often lack discretion, which increases the risk of vandalism and theft.

FR 2 896 069 proposed, for a fluid meter remote-reading device, in particular a water meter installed in an underground manhole provided with a manhole cover, using this cover as an antenna. In the case where the cover is made of a non-electrically-conductive material, this prior document proposes flush-mounting or molding the antenna in the manhole cover. This solution is relatively costly because it entails manufacturing a special manhole cover. Furthermore, it lacks flexibility since replacing the antenna entails replacing the manhole cover.

The aim of the invention is, primarily, to provide a GSM antenna that is specially suited to the urban or industrial environment and which can be easily fixed flat on or flush in any type of horizontal or vertical support. It is desirable for the antenna to be discreet and robust.

According to the invention, a GSM antenna for transmitting or receiving information between a machine, or a network of machines, and a server, comprising a metal strand embedded in an insulating material, is characterized in that the insulating material forms a flat shield designed to provide mechanical protection and a seal around the metal strand, and in that the thickness of the antenna with its shield is less than 20 mm.

Preferably, the edges of the shield are beveled with decreasing thickness to reduce the risks of catching the antenna.

The antenna according to the invention operates perfectly on a metal or non-metal support; it can be installed on the cover of a manhole on a sidewalk or roadway, without being an obstruction to the traffic and in total discretion. It can cope with the passage of vehicles; it offers total seal-tightness and can not easily be torn away or damaged.

The flat shield is advantageously produced in two parts designed to be assembled, namely a central part comprising the metal strand, and provided with fastening means, notably holes, around its perimeter and a frame designed to be fastened to the central part, notably by clipping or snap-fitting, to mask the fastening means.

The fastening of the frame on the central part can be designed to be non-removable, after a first assembly, without damaging it. The assembly can therefore be qualified as inviolable.

The antenna according to the invention is standalone and independent of the infrastructure equipment to which it will be fastened.

Advantageously, the central part of the flat shield is in the form of a disk whereas the frame is formed by a ring which surrounds the central part. The antenna may comprise a collar with holes forming fastening means of the antenna.

The thickness of the antenna with its shield is preferably around 10 mm. When the antenna is designed to be fastened flat on a non-metal support, a metal washer is positioned against the face of the shield turned toward the support.

The dimensions of the antenna are designed to enable the antenna to fit within a 20 cm×20 cm square. Preferably the outer contour of the antenna is situated between a 20 cm×20 cm outer square and a 10 cm×10 cm inner square.

The antenna includes an output cable either in the axis, or arranged laterally.

The invention consists, apart from the provisions explained hereinabove, of a certain number of other arrangements, which will be more explicitly described hereinbelow with regard to exemplary embodiments described with reference to the appended drawings, but which are in no way limiting. In these drawings:

FIG. 1 is a schematic vertical cross section of an antenna according to the invention fitted on a metal cover which seals a manhole in which a water meter is installed.

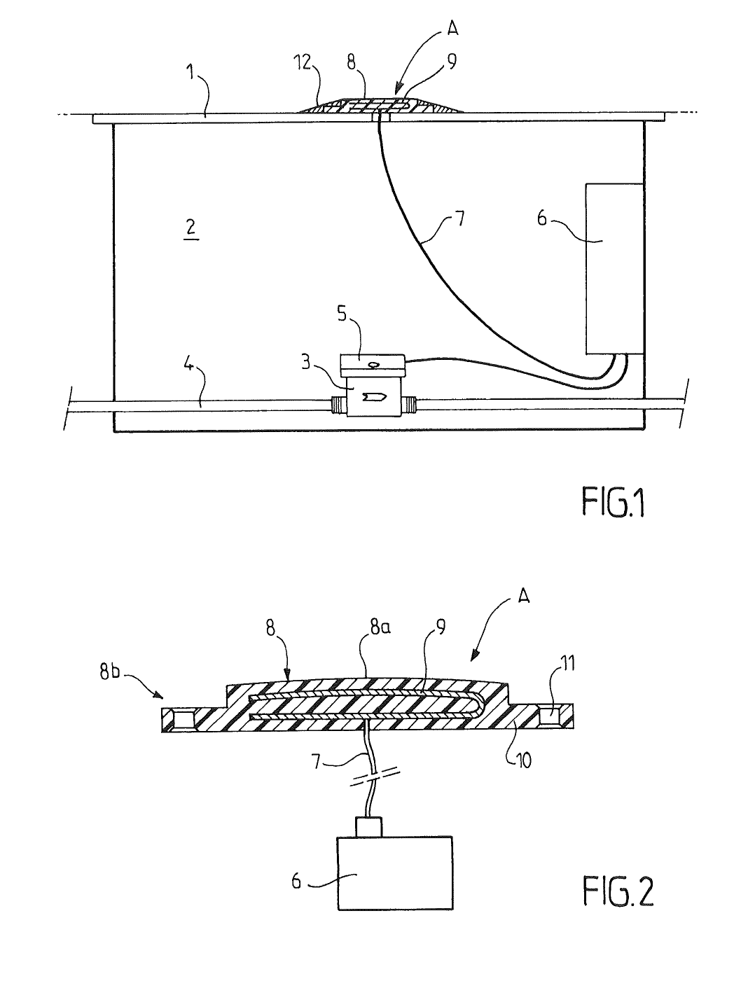

FIG. 2 is a schematic vertical cross section, on a larger scale, of the central part of the antenna with its metal strand.

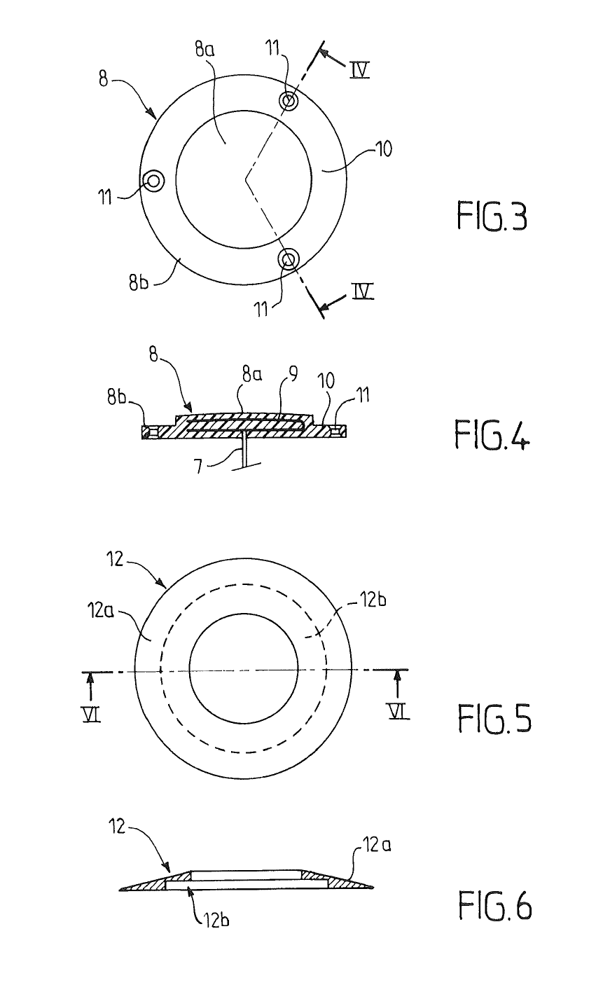

FIG. 3 is a plan view of an antenna, the active part of which is circular.

FIG. 4 is a vertical cross section along the broken line IV-IV of FIG. 3.

FIG. 5 is a plan view of the ring together with the central part of FIG. 3.

FIG. 6 is a vertical cross section along the line VI-VI of FIG. 5.

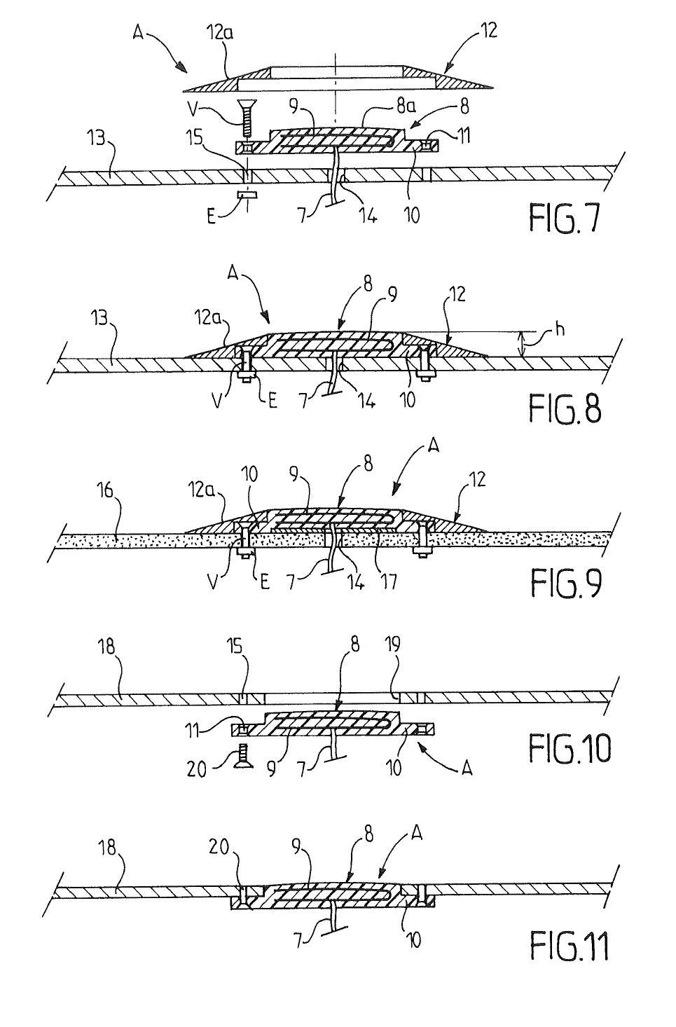

FIG. 7 is a vertical cross sectional view of an antenna while being mounted flat on a horizontal metal support.

FIG. 8 is a vertical cross section of the mounted antenna of FIG. 7.

FIG. 9 is a vertical cross section of an antenna mounted flat on a non-metal support.

FIG. 10 is a vertical cross section of an antenna while being flush-mounted on a horizontal support and

FIG. 11 is a vertical cross section of the flush-mounted antenna.

Referring to FIG. 1 in the drawings, an antenna A according to the invention can be seen installed flat on a metal cover 1 of an underground manhole 2 in which a water meter 3 is installed, mounted on a pipe 4. The meter 3 is equipped with a measurement sensor 5 linked by a cable to a GPRS transmitter 6. The antenna A is linked by a coaxial cable 7 to the transmitter (emitter/receiver) 6.

The information gathered by the sensor 5 can thus be transmitted remotely to a server (not represented) which centralizes the data. Instructions can also be transmitted by the server and collected by the antenna A and the transmitter 6.

The antenna A has a central part 8 (FIG. 2), or active part, incorporating the components needed for GSM transmission and reception. This active part 8 is made of a molded material. A metal strand 9 (FIG. 2), and possibly electronic components, is embedded in the active part 8 made of insulating material. This part 8 forms a shield providing mechanical protection for the metal strand and for the components necessary for GSM transmission and reception, as well as the part of the coaxial cable 7 connected to the strand 9.

The active part 8 is made of an insulating and mechanically resistant material to provide a mechanical protection index that satisfies the IP68 protection requirements. The active part 8 may be made of plastic material reinforced with hardened fibers. The plastic material used for the antenna A advantageously consists of glass-fiber-filled polycarbonate. The top face 8a is slightly raised, outwardly convex, to facilitate the drainage of water when the part 8 is mounted horizontally. A collar 10, of lesser thickness, surrounds the active part and includes evenly distributed holes 11 forming fastening means for the antenna A. The holes 11 enable the active part to be fastened to an infrastructure, either horizontally or vertically.

According to the exemplary embodiment of FIGS. 3 and 4, the active part 8 is circular and the collar 10 includes three holes 11 at a 120° spacing. Generally, the diameter of the raised part 8a is approximately 50 mm, less than 70 mm. The outer diameter of the ring 10 is around 90 mm, generally less than 100 mm.

A frame 12 (FIGS. 1, 5 and 6) is provided to mask the holes 11 and the fastenings to the infrastructure. This frame 12 also has a transverse section of outwardly decreasing thickness with an inclined outer face 12a to ensure a gradual and continuous connection of the edge of the raised surface 8a with the surface of the support infrastructure.

A double setback 8b is formed by the transition from the raised part 8a to the collar 10 and by the thickness of this collar. This double setback 8b corresponds to a double setback 12b of the inner surface of the frame 12, which is designed to marry with the setback 8b. Snugs and recesses (not visible) are provided respectively on the two setbacks 8b, 12b. The frame 12 is fastened by clipping or snap-fitting by force, by cooperation of the snugs and recesses. The frame 12 is used to mask the fastenings to the infrastructure while providing, by its inclined form, an effective protection against lateral impacts and tearing. In the case where the active part 8 has a circular form, the frame 12 consists of a circular ring (FIG. 5).

Preferably, the outer contour of the antenna, central part and frame, is situated between a 20 cm×20 cm outer square and a 10 cm×10 cm inner square with sides parallel to those of the outer square. Advantageously, the diameter of the circle circumscribed on the apparent contour of the antenna, seen from a direction perpendicular to a planar surface on which it is fastened, is at least equal to five times the thickness of the antenna in that direction.

The simple and discreet form of the assembly formed by the frame 12 and the active part 8 means that the presence of a GSM transmission device in proximity is not easy to identify, the SIM card of such a transmission device being fairly sought-after. The totally smooth form of the antenna A as a whole, without unevenness or grip, makes any attempt to tear it away difficult.

The force clipping of the frame 12 onto the active part 8 can be designed to be irreversible, that is to say that, to remove this frame, it has to be damaged. The antenna A can therefore be qualified as inviolable.

The coaxial cable 7 of the antenna can exit in the axis of the antenna A, or can exit laterally, passing through the protective material.

FIGS. 7 and 8 illustrate the mounting flat of the antenna A on a metal support 13 consisting of a plate, for example made of cast iron or of steel plate. The support 13 includes an orifice 14 for the entry of the coaxial cable 7 and holes 15 distributed to correspond to the holes 11 of the collar. This collar 10 is fastened to the plate 13 by screws V passing through the holes 11, 15 and secured by a nut E on the side of the plate 13 opposite the antenna A.

After the active part 8 has been fastened, the frame 12 is force clipped onto the part 8 as illustrated in FIG. 8. Since the support plate 13 is metal, the active part 8 is placed directly against this plate. The overall thickness h of the assembled antenna A is around 10 mm so the risks of catching are almost nonexistent, notably because of the inclined edges 12a of the ring. The assembly is seal-tight and the screws V are masked from sight.

In the case where the antenna A is fastened onto a non-metal support 16, as illustrated in FIG. 9, a metal washer 17, serving as ground plane for the antenna, is inserted between the active part 8 and the support 16. Preferably, this metal washer 17 is inserted into the active part 8, notably when molding, so that the bottom face of the washer 17 is in the same plane as the bottom face of the collar 10 and of the ring 12.

FIGS. 10 and 11 illustrate a flush mounting of the active part 8 in a metal support 18 including an opening 19, the diameter of which corresponds to that of the top raised part 8a which is housed, in a tight-fitting manner, in this opening 19. The part 8 is fastened by self-tapping screws 20 or by rivets, the top ends of which are flush with the surface of the plate 18, without protruding from this plate.

An antenna A according to the invention can be installed on a roadway, because it withstands the passage of light or heavy vehicles.

One particularly interesting use of this type of antenna is to enable GSM/GPRS gateways to connect to the GSM network in good conditions, even when these gateways are installed in places that are unfavorable to the propagation of radio waves, for example in underground premises (cellars) or manholes 2 (FIG. 1) covered with a metal cover, the transmitter 6 being located in the underground manhole. Measurement campaigns have demonstrated reception level differences between the interior and the exterior of the manhole of around 15 to 30 dBm, even more when the cover 1 is made of thick cast iron. The installation of the antenna A outside the manhole allows for a substantial improvement in communication.

In terms of performance, a gain of 0 dBi (no gain, no loss) will be sought in the two GSM frequencies of 900 MHz and 1800 MHz, independently of the type of support on which the antenna will be fastened. The impedance will be 50 ohms.

The antenna according to the invention is suitable for any transmission, notably for centralized technical management. The antenna, satisfying the IP68 requirements, is totally water- and dust-tight.

The antenna can be fastened on urban fixtures and fittings. This antenna is independent of the infrastructure on which it is fastened. It can be used in numerous applications, for example for the management of containers, skips, trash cans, which will be provided with transmitters equipped with such an antenna.

1.-9. (canceled)

10. A GSM antenna for transmitting or receiving information between a machine, or a network of machines, and a server, comprising a metal strand (9) embedded in an insulating material, wherein the insulating material forms a flat shield (8) designed to provide mechanical protection and a seal around the metal strand, and in that the thickness (h) of the antenna with the shield is less than 20 mm.

11. The antenna as claimed in claim 10, wherein the edges (12a) of the shield are beveled with decreasing thickness to reduce the risks of catching the antenna.

12. The antenna as claimed in claim 10, wherein the flat shield is produced in two parts (8, 12) designed to be assembled, namely a central part (8) comprising the metal strand (9), and provided with fastening means (11) around a perimeter, and a frame (12) designed to be fastened to the central part, notably by clipping or snap-fitting, to mask the fastening means.

13. The antenna as claimed in claim 12, wherein the fastening of the frame (12) on the central part (8) is designed to be non-removable, after a first assembly, without damaging it.

14. The antenna as claimed in claim 12, wherein the central part (8) of the flat shield is in the form of a disk whereas the frame (12) is formed by a ring which surrounds the central part.

15. The antenna as claimed in claim 12, further comprising a collar (10) with holes forming fastening means of the antenna.

16. The antenna as claimed in claim 10, wherein the thickness (h) of the antenna is around 10 mm.

17. The antenna as claimed in claim 10, configured to be fastened flat on a non-metal support, wherein a metal washer (17) is positioned against the face of the shield turned toward the support.

18. The antenna as claimed in claim 10, having dimensions designed to enable the antenna to fit within a 20 cm×20 cm square.
